(19) United States
(12) Patent Application Publication
(10) Pub. No.: US 2012/0083206 A1
(43) Pub. Date: Apr. 5, 2012

(54) COMMUNICATION SYSTEM

(75) Inventors: Tomita Obara, Miyagi (JP); Naoki Adachi, Kanagawa (JP)

(73) Assignee: PANASONIC CORPORATION, Osaka (JP)

(21) Appl. No.: 13/375,293

(22) PCT Filed: Feb. 25, 2010
(86) PCT No.: PCT/JP2010/001296

§ 371 Date: Nov. 30, 2011

(30) Foreign Application Priority Data
Jun. 1, 2009 (JP) 2009-131743

(51) Int. Cl. H04B 5/00

(52) U.S. Cl. 455/41.1

(57) ABSTRACT

In a communication system that performs recharging operation and short-range data communication between a portable terminal and a cradle, when a communication unit of the cradle is halted for power saving purpose, there is no unit available to activate the communication unit of the cradle through operation of the portable terminal when data communication is commenced while the portable terminal remains placed in the cradle. A first control unit 22 activates a first communication unit 24 according to an output of an open state detection unit 23 that detects an open state of a portable terminal 20. A second control unit 27 activates a second communication unit 26 of the cradle according to an output of an opened terminal detection unit 25 that detects placement of the opened portable terminal 20. As a result, the first communication unit 24 and the second communication unit 26 are activated by opening the portable terminal 20, whereby bidirectional communication can be established therebetween.

### TECHNICAL FIELD

The present invention relates to a communication system made up of a portable terminal and a cradle and, more particularly, to activation of a communication unit belonging to the cradle.

### BACKGROUND ART

A system that transmits and receives information and that also charges a portable terminal by means of a connection of an information processing device, like a PC (Personal Computer), with the portable terminal, like a cell phone, has recently been used. Moreover, example use of a cradle for a connection of a portable terminal with an information processing device has been observed.

When recharging and transmission/receipt of information are performed by way of a cradle in such a manner as mentioned above, there is required a switch used for initiating operation when the terminal device is set on the cradle. When a press switch is used at this time, an opening section is susceptible to dust entry, which is also likely to cause a failure. For this reason, there has hitherto been known a technique for placing a Hall IC in the cradle, to thus detect magnetism of a magnet incorporated in the terminal device (see; for instance, Patent Document 1). The Hall IC incorporated in the cradle detects magnetism, whereby the cradle detects placement of the portable terminal and can initiate transmission/receipt of information and recharging operation.

When communication is established between a portable terminal and an external device, selecting the most appropriate one from a plurality of communication modes according to a purpose is also conducted. On this occasion, in order to avoid compelling the user to set a communication mode by performing a complicate operation with buttons, or the like, there is a hitherto known technique of bringing respective folded states of a portable terminal that can be folded in a plurality of states into correspondence with communication modes. The technique (see; for instance, Patent Document 2) makes it possible to easily switch a communication mode by changing only a shape of the portable terminal.

### RELATED ART DOCUMENT

### Patent Document

Patent Document 1: JP-A-2005-110332
Patent Document 2: JP-A-2007-43243

### DISCLOSURE OF THE INVENTION

### Problem that the Invention is to Solve

In such a system in which recharging and communication are performed between the portable terminal and the cradle, it is also considered that the portable terminal is placed on the cradle only for recharging purpose. In order to curtail power consumption, a communication unit should not be activated at this time. However, according to the invention described in connection with Patent Document 1, communication is initiated at a point in time when the portable terminal is placed on the cradle. Therefore, if there is a desire to initiate communication in the course of recharging operation as a result of the portable device being placed on the cradle, there has been a problem of no unit being available to start communication unit of the cradle.

Likewise, in the invention described in connection with Patent Document 2, a communication mode can be switched by changing a folded state of the terminal. However, only contact communication that is performed by way of a contact point is taken into account in connection with a communication with the cradle. Therefore, there has been a problem of no method being available to activate a communication unit of the cradle that is required when non-contact communication is performed.

The present invention has been conceived to solve the problems and aims at providing a communication system that activates a non-contact communication unit of a cradle without involvement of complicate operation while the portable terminal remains placed on the cradle.

### Means for Solving the Problem

In order to solve the problem of the related art, a communication system of the present invention includes

a portable terminal having an open state detection unit detecting an open state of the portable terminal and a first control unit that activates first communication unit as a result of the open state detection unit having detected an open state of the portable terminal; and

a cradle having an opened terminal detection unit detecting that the opened portable terminal is placed and a second control unit that activates second communication unit as a result of the opened terminal detection unit having detected placement of the portable terminal remaining in an open state. The first and second communication units are activated by opening the portable terminal placed in the cradle.

The configuration makes it possible to activate the communication unit of the cradle in a non-contact manner while the portable terminal remains placed, without involvement of performance of complicate operation.

A communication system of the present invention includes a portable terminal having state-of-being-placed detection unit detecting that the portable terminal is placed in a cradle while remaining open and a first control unit that activates first communication unit as a result of the state-of-being-laced detection unit having detected placement of the portable terminal remaining in an open state; and a cradle having opened terminal detection unit detecting that the opened portable terminal is placed and second control unit that activates second communication unit as a result of the opened terminal detection unit having detected placement of the portable terminal remaining in an open state. The first and second communication units are activated by opening the portable terminal placed in the cradle.

The configuration makes it possible to activate the communication unit of the cradle in a non-contact manner while the portable terminal remains placed, without involvement of performance of complicate operation.

A communication system of the present invention includes a portable terminal having operation unit by way of which operation for activating first communication unit is performed, a notifying unit notifying a cradle that the first communication unit is activated, and a first control unit that activates the first communication unit and the notifying unit in accordance with operation of the operation unit; and the cradle having a terminal detection unit detecting a notification from the notifying unit and second control unit that activates second communication unit as a result of the terminal detection unit having detected an activated state of the first communication unit. The first and second communication units are activated by opening the portable terminal placed in the cradle.

The configuration makes it possible to activate the communication unit of the cradle in a non-contact manner while the portable terminal remains placed, without involvement of performance of complicate operation.

### ADVANTAGE OF THE INVENTION

The communication system of the present invention enables activation of communication unit of a cradle by bringing a terminal placed on the cradle into an open state and also makes it possible to perform power thrifty operation by halting the communication unit when unneeded.

### BRIEF DESCRIPTION OF THE DRAWINGS

FIG. 1 is a block diagram showing a general configuration of a communication system of a first embodiment of the present invention.

FIGS. 2 (a) and (b) are general cross sectional views showing usage examples of the communication system of the first embodiment of the present invention, wherein (a) it is a general cross sectional view showing a usage example in which a closed portable terminal is placed and (b) it is a general cross sectional view showing a usage example in which an open portable terminal is placed.

FIGS. 3 (a) and (b) are general cross sectional views showing usage examples of the communication system of the first embodiment of the present invention, wherein (a) it is a general cross sectional view showing a usage example in which the closed portable terminal is placed and (b) it is a general cross sectional view showing a usage example in which the open portable terminal is placed.

FIGS. 4 (a) and (b) are general cross sectional views showing usage examples of the communication system of another form of the first embodiment of the present invention, wherein (a) it is a general cross sectional view showing a usage example in which the closed portable terminal is placed and (b) it is a general cross sectional view showing a usage example in which the open portable terminal is placed.

FIGS. 5(a) and (b) are general cross sectional views showing usage examples of the communication system of still another form of the first embodiment of the present invention, wherein (a) it is a general cross sectional view showing a usage example in which the closed portable terminal is placed and (b) it is a general cross sectional view showing a usage example in which the open portable terminal is placed.

FIGS. 6(a) and (b) are general cross sectional views showing usage examples of a communication system of a second embodiment of the present invention, wherein (a) it is a general cross sectional view showing a usage example in which the closed portable terminal is placed and (b) it is a general cross sectional view showing a usage example in which the open portable terminal is placed.

FIG. 7 is a block diagram showing a general configuration of a communication system of a third embodiment of the present invention.

FIG. 8 is a general cross sectional view showing a usage example of the communication system of the third embodiment of the present invention.

### EMBODIMENTS FOR IMPLEMENTING THE INVENTION

Embodiments of the present invention are now described.

### First Embodiment

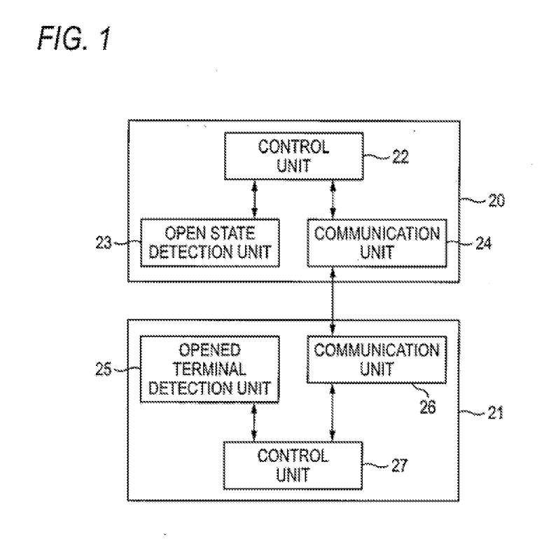

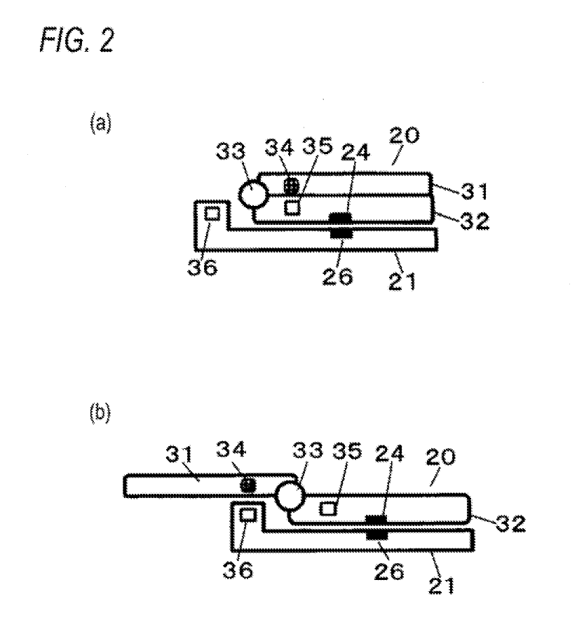

FIG. 1 is a block diagram showing a general configuration of a communication system of a first embodiment of the present invention. FIGS. 2(a) and (b) are general cross sectional views showing usage examples of the communication system.

The communication system includes a portable terminal 20 and a cradle 21.

The portable terminal 20 is equipped with a first control unit 22, an open state detection unit 23 detecting an open state of the portable terminal 20, and a first communication unit 24 establishing non-contact data communication with the cradle 21 on which the portable terminal 20 is to be placed. The first control unit 22 activates the first communication unit 24 according to an output from the open state detection unit 23.

The cradle 21 is equipped with a second control unit 27, a second communication unit 26 establishing non-contact data communication with the portable terminal 20, and an open terminal detection unit 25 detecting that the opened portable terminal 20 is placed. The second control unit 27 activates the second communication unit 26 according to an output from the opened terminal detection unit 25. The cradle 21 is configured in such a way that the portable terminal 20 is placed at a predetermined position in a predetermined manner.

As shown in FIGS. 2(a) and (b), the terminal device 20 is equipped with a first enclosure 31, a second enclosure 32, and a hinge 33 for coupling the first enclosure 31 to the second enclosure 32; and is configured so as to be foldable. The terminal device 20 is additionally equipped with the open state detection unit 23 for detecting whether the first enclosure 31 and the second enclosure 32 are in a closed state, such as shown in FIG. 2(a,) and in an open state, such as that shown in FIG. 2(b).

The open state detection unit 23 is made up of a magnet 34 incorporated in the first enclosure and first magnetism detection unit 35 incorporated in the second enclosure. When the closed terminal device 20 shifts to an open state, a distance between the magnet 34 and the first magnetism detection unit 35 changes according to the position of the magnet 34 incorporated in the first enclosure 31. Magnetic field intensity detected by the first magnetism detection unit 35 also changes according to the change in distance. When the first control unit 22 determines that the portable terminal 20 is open in accordance with an output from the first magnetism detection unit 35, the first control unit 22 activates the first communication unit 24.

The cradle 21 is equipped with the opened terminal detection unit 25 that detects whether or not the portable terminal 20 placed on the cradle is open as shown in FIG. 2(b). The opened terminal detection unit 25 is made up of second magnetism detection unit 36 and the magnet 34 incorporated in the first enclosure 31 of the portable terminal 20.

When the portable terminal 20 placed on the cradle shifts to an open state, a distance between the magnet 34 and the second magnetism detection unit 36 changes according to the position of the magnet 34 incorporated in the first enclosure 31 of the portable 20. Magnetic field intensity detected by the second magnetism detection unit 36 also changes according to the change in distance. When the second control unit 27 determines that the portable terminal 20 is open in accordance with an output from the second magnetism detection unit 36, the second control unit 27 activates the second communication unit 26.

As mentioned above, according to the present embodiment, a signal for commencing communication is sent to the cradle 21 without involvement of special operation by means of only detecting magnetism of the magnet 34 incorporated in the first enclosure 31 of the portable terminal 20 and bringing the portable terminal 20 into an open state, thereby activating the first communication unit 24 and the second communication unit 26, to thus establish bidirectional communication therebetween.

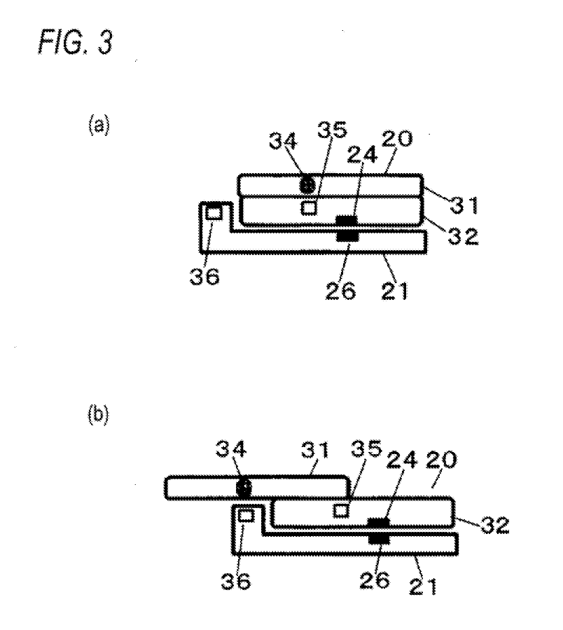

The portable terminal 20 has been described as having a twofold structure that makes it possible to fold the first enclosure 31 and the second enclosure 32. However, as shown in FIGS. 3(a) and (b), the portable terminal 20 can also assume a slide shape that allows sliding of the first enclosure 31 and the second enclosure 32.

Only a receiving function of the first communication unit may be activated when the open state detection unit has detected an open state. Further, after a communication initiation start signal has been received from the second communication unit, a transmission function of the first communication unit may be activated. Thereby, the first communication unit is activated only when the second communication unit is activated, so that more power thrifty operation can be performed.

In the embodiment, the second magnetism detection unit 36 incorporated in the cradle 21 detects magnetism of the magnet 34 incorporated in the portable terminal 20. However, the magnet 34 can be an electronic component incorporating a magnet (e.g., a speaker for annunciating a ring tone). Adopting such a configuration makes it possible to divert components commonly incorporated in a portable terminal device for the portable terminal. As a result, there is yielded an advantage of obviation of a necessity for adding a new component to the portable terminal 20.

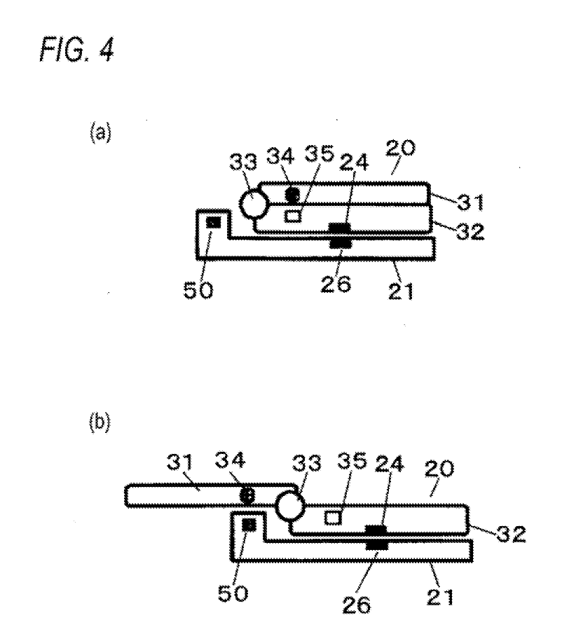

FIGS. 4(a) and (b) are general cross sectional views showing usage examples of the communication system of another form of the present embodiment. The opened terminal detection unit 25 is made up of luminance detection unit 50 for detecting brightness of surroundings. The luminance detection unit 50 is placed at a location where the first enclosure 31 covers the luminance detection unit 50 when the portable terminal 20 is brought into an open state. Thereby, when the portable terminal 20 placed on the cradle shifts to an open state, luminance detected by the luminance detection unit 50 falls. When the second control unit 27 determines, on the basis of an output from the luminance detection unit 50, that the portable terminal 20 is in the open state, the second communication unit 26 is activated, so that bidirectional communication can be established therebetween.

In the embodiment shown in FIGS. 4(a) and (b), a fall in luminance which arises when the first enclosure 31 of the portable terminal 20 covers the luminance detection unit 50 of the cradle 21 is detected. However, another configuration is also adopted. Namely, a light emitting component (e.g., a liquid crystal display device, an LED, or the like) is incorporated in the first enclosure 31. When the portable terminal 20 is brought into an open state, the luminance detection unit 50 detects an increase in luminance induced by illumination of the light emitting component. This enables implementation of the following configuration. Namely, a specific pattern is laid by switching illumination of the light emitting component along a time axis. When the pattern is detected, the second control unit 27 activates the second communication unit 26, whereby the chance of occurrence of erroneous detection of illumination can be diminished.

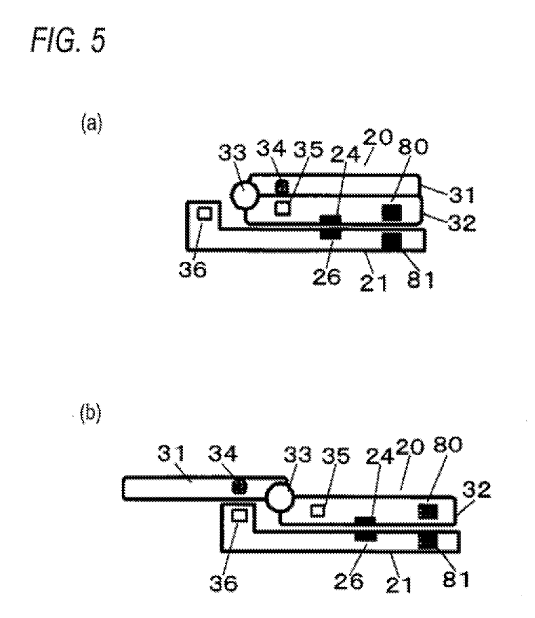

FIGS. 5(a) and (b) are general cross sectional views showing usage examples of the communication system of yet another form of the embodiment. The portable terminal 20 is equipped with state-of-being-placed detection unit 80 for detecting that the portable terminal 20 is placed on the cradle 21. The cradle 21 is equipped with placement detection unit 81 for detecting that the portable terminal 20 is placed on the cradle 21.

The configuration makes it possible to detect that the portable terminal 20 and the cradle 21 are in a predetermined positional relationship. When the portable terminal 20 is brought into an open state, the first communication unit and the second communication unit make it possible to establish more stable communication.

### Second Embodiment

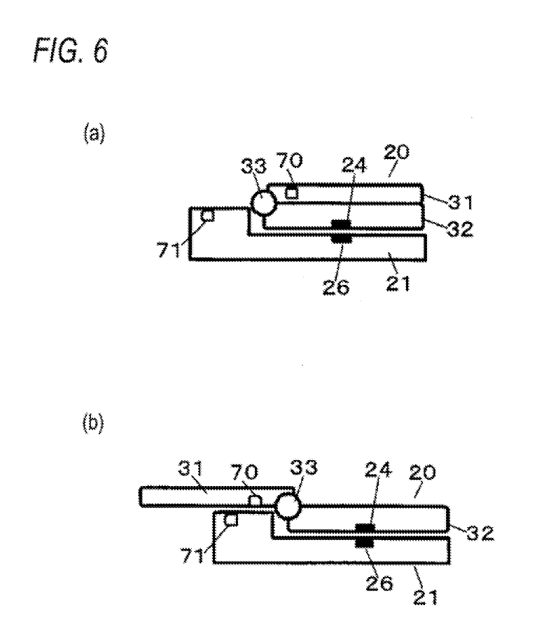

FIGS. 6(a) and (b) are general cross sectional views showing usage examples of a communication system of a second embodiment of the present invention. In connection with the embodiment, operation of the communication system is described by use of FIGS. 6(a) and (b).

As shown in FIGS. 6(a) and (b), the terminal device 20 is equipped with the first enclosure 31, the second enclosure 32, and the hinge 33 that couples the first enclosure 31 and the second enclosure 32 together. The terminal device 20 is configured so as to be foldable. The terminal device 20 has the open state detection unit 23 for determining that the terminal device is opened (an open state) as shown in FIG. 6(b).

The open state detection unit 23 is made up of first proximity detection unit 70 (e.g., a capacitance proximity sensor) that is incorporated in the first enclosure and that detects an approach of an object in a contactless manner. When the portable terminal 20 in a closed state, such as that shown in FIG. 6(a), shifts to an open state, such as that shown in FIG. 6(b), the first proximity detection unit 70 incorporated in the first enclosure 31 approaches the cradle 21. Hence, an output of the first proximity detection unit 70 changes with a change in distance. When determined, from an output from the first proximity detection unit 70, that the portable terminal 20 is in an open state, the first control unit 22 activates the first communication unit 24.

The cradle 21 is equipped with the opened terminal detection unit 25 that detects whether or not the portable terminal 20 placed in the cradle is opened as shown in FIG. 6(b). The opened terminal detection unit 25 is made up of second proximity detection unit 71 that detects an approach of an object in a contactless manner.

When the portable terminal 20 placed in the cradle shifts to an open state, such as that shown in FIG. 6(b), the second proximity detection unit 71 approaches the first enclosure 31 of the portable terminal 20. Hence, an output of the second proximity detection unit 71 changes with a change in distance. When determined, from an output from the second proximity detection unit 71, that the portable terminal 20 is in an open state, the second control unit 27 activates the second communication unit 26.

As mentioned above, according to the present embodiment, the first proximity detection unit 70 and the second proximity detection unit 71 that are incorporated in the first enclosure 31 of the portable terminal 20 and the enclosure of the cradle 21 detect an approach between the first enclosure to the enclosure of the cradle 21. Hence, each of the first and second proximity detection unit detects that the portable terminal 20 has shifted to an open state, so that the first and second communication unit 24 and 26 can be activated.

In the embodiment shown in FIGS. 6(a) and (b), the portable terminal 20 has been described by taking, as an example, a twofold terminal that can be folded by means of the first enclosure 31 and the second enclosure 32. The portable terminal 20 can also assume a slide shape that enables sliding of the first enclosure 31 and the second enclosure 32.

### Third Embodiment

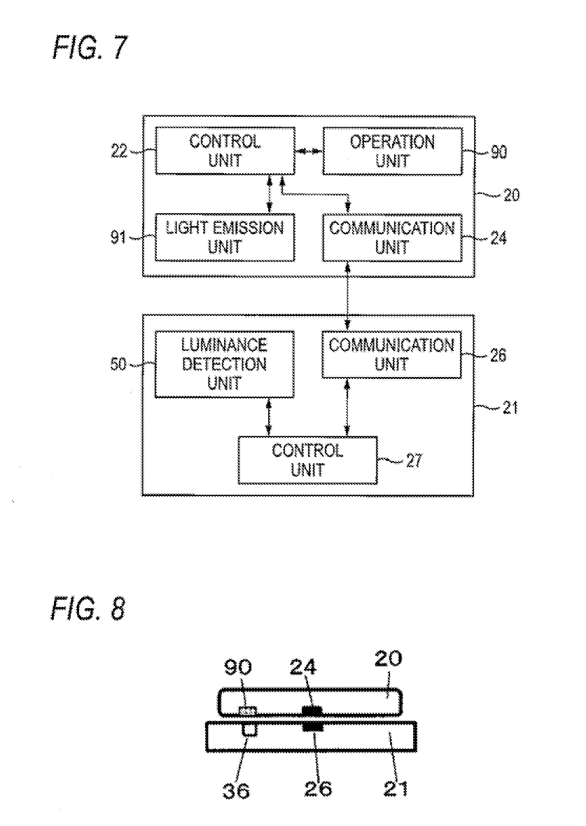

FIG. 7 is a block diagram showing a general configuration of a communication system of a third embodiment of the present invention, and FIG. 8 is a general cross sectional view showing a usage example of the communication system of the third embodiment of the present invention.

As shown in FIG. 7, the communication system of the present embodiment is made up of the portable terminal 20 and the cradle 21. The portable terminal 20 is equipped with the first control unit 22; the first communication unit 24 that establishes non-contact data communication with the cradle 21 on which the portable terminal 20 is to be placed; operation unit 90 that activates the first communication unit 24; and light emitting unit 91 that is provided on a surface of the portable terminal 20 that contacts the cradle 21 when the portable terminal 20 is placed on the cradle. The portable terminal 20 is configured such that, when the first communication unit 24 is activated by operation of the operation unit 90, the first control unit 22 activates the light emitting unit 91.

The cradle 21 includes the second control unit 27; the second communication unit 26 that establishes non-contact data communication with the portable terminal 20; and the luminance detection unit 50 that detects a change in luminance resulting from illumination of the light emitting unit 91. The cradle 21 is configured in such a way that the second control unit 27 activates the second communication unit 26 according to an output of the luminance detection unit 50.

As mentioned above, according to the present embodiment, when the first communication unit 24 is activated by operation of the operation unit 90 of the portable terminal 20, the light emission unit 91 emits light, and the luminance detection unit 50 detects illumination of the light emission unit 91, thereby sending a signal of commencement of communication to the cradle. The cradle 21 activates the second communication unit 26, whereby bidirectional communication can be established therebetween.

Although the present invention has been described in detail and by reference to the specific embodiments, it is manifest to those skilled in the art that the present invention be susceptible to various alterations and modifications without departing the spirit and scope of the invention.

The present patent application is based on Japanese Patent Application (JP-2009-131743) filed on Jun. 1, 2009, the entire subject matter of which is incorporated herein by reference.

### INDUSTRIAL APPLICABILITY

In the communication system of the present invention, the communication unit of the cradle can be activated by opening the terminal placed in the cradle as a result of the first communication unit being activated by detection of an open state of the portable terminal and the second communication unit being activated by the opened terminal detection unit of the cradle. Therefore, communication unit can be halted when unneeded, and power thrifty operation becomes possible. Thus, the present invention is useful for activation of communication unit, as in a communication system made up of a portable terminal and a cradle.

### DESCRIPTIONS OF THE REFERENCE NUMERALS AND SYMBOLS

20 PORTABLE TERMINAL
21 CRADLE
22 FIRST CONTROL UNIT
23 OPEN STATE DETECTION UNIT
24 FIRST COMMUNICATION UNIT
25 OPENED TERMINAL DETECTION UNIT
26 SECOND COMMUNICATION UNIT
27 SECOND CONTROL UNIT
31 FIRST ENCLOSURE
32 SECOND ENCLOSURE
33 HINGE
34 MAGNET
35 FIRST MAGNETISM DETECTION UNIT
36 SECOND MAGNETISM DETECTION UNIT
50 LUMINANCE DETECTION UNIT
70 FIRST PROXIMITY DETECTION UNIT
71 SECOND PROXIMITY DETECTION UNIT
80 STATE-OF-BEING-PLACED DETECTION UNIT
81 PLACEMENT DETECTION UNIT
90 OPERATION UNIT
91 LIGHT EMISSION UNIT
FIG. 1
22 CONTROL UNIT
23 OPEN STATE DETECTION UNIT
24 COMMUNICATION UNIT
25 OPENED TERMINAL DETECTION UNIT
26 COMMUNICATION UNIT
27 CONTROL UNIT
FIG. 7
22 CONTROL UNIT
90 OPERATION UNIT
24 COMMUNICATION UNIT
91 LIGHT EMISSION UNIT
26 COMMUNICATION UNIT
50 LUMINANCE DETECTION UNIT
27 CONTROL UNIT

1. A communication system that establishes non-contact data communication between a portable terminal and a cradle on which the portable terminal is placed, the system comprising:
the portable terminal including a first communication unit establishing non-contact data communication with the cradle, an open state detection unit detecting an open state of the portable terminal, and a first control unit that activates the first communication unit as a result of the open state detection unit having detected an open state of the portable terminal; and
the cradle including a second communication unit establishing non-contact data communication with the portable terminal, an opened terminal detection unit detecting that the opened portable terminal is placed, and a second control unit that activates the second communication unit as a result of the opened terminal detection unit having detected placement of the portable terminal remaining in an open state.

2. The communication system according to claim 1, wherein the portable terminal has a folding structure in which a first enclosure and a second enclosure are reclosably coupled together by a hinge;
the open state detection unit detects that the portable terminal is in a state where the folding structure is opened; and
the opened terminal detection unit detects that the portable terminal is placed in the cradle while the folding structure remains open.

3. The communication system according to claim 1, wherein the portable terminal has a slide structure by means of which a first enclosure and a second enclosure are coupled together so as to be extendable by sliding action;
the open state detection unit detects that the portable terminal is in a state where the slide structure is opened as a result of sliding action of the first enclosure and the second enclosure; and
the opened terminal detection unit detects that the portable terminal is placed on the cradle while the slide structure remains open as a result of sliding action of the first enclosure and the second enclosure.

4. The communication system according to claim 2, further comprising:
a magnet incorporated in the first enclosure and first magnetism detection unit incorporated in the second enclosure, wherein
the open state detection unit detects an open state of the portable terminal according to a state of magnetism of the magnet being detected by the first magnetism detection unit; and
the opened terminal detection unit has second magnetism detection unit provided in the cradle and detects placement of the opened portable terminal from a state of magnetism of the magnet being detected by the second magnetism detection unit.

5. The communication system according to claim 3, further comprising:
a magnet incorporated in the first enclosure and first magnetism detection unit incorporated in the second enclosure wherein
the open state detection unit detects an open state of the portable terminal according to a state of magnetism of the magnet being detected by the first magnetism detection unit; and
the opened terminal detection unit has second magnetism detection unit provided in the cradle and detects placement of the opened portable terminal from a state of magnetism of the magnet being detected by the second magnetism detection unit.

6. A communication system that establishes non-contact data communication between a portable terminal and a cradle on which the portable terminal is placed, the system comprising:
the portable terminal including a first communication unit establishing non-contact data communication with the cradle, a state-of-being-placed detection unit detecting that the portable terminal is placed in the cradle while remaining open, and a first control unit that activates the first communication unit as a result of the state-of-being-placed detection unit having detected placement of the portable terminal on the cradle remaining in an open state; and
a cradle including second communication unit establishing non-contact data communication with the portable terminal, an opened terminal detection unit detecting that the opened portable terminal is placed, and a second control unit that activates the second communication unit as a result of the opened terminal detection unit having detected placement of the portable terminal in an open state.

7. The communication system according to claim 6, wherein the state-of-being-placed detection unit has first proximity detection unit and detects approach of the portable terminal to the cradle as a result of the first proximity detection unit having detected that the cradle has made an approach in an open state; and
the opened terminal detection unit has a second proximity detection unit and detects approach of the portable terminal remaining in an open state to the cradle as a result of the second proximity detection unit having detected approach of the opened portable terminal.

8. A communication system that establishes non-contact data communication between a portable terminal and a cradle on which the portable terminal is placed, the system comprising:
the portable terminal including a first communication unit establishing non-contact data communication with the cradle, an operation unit by which operation for activating the first communication unit is performed, a notifying unit for notifying the cradle that the first communication unit is activated, and a first control unit that activates the first communication unit and the notifying unit in accordance with operation of the operation unit; and
the cradle including a second communication unit establishing non-contact data communication with the portable terminal, a terminal detection unit detecting a notification from the notifying unit, and a second control unit that activates the second communication unit as a result of the terminal detection unit having detected an activated state of the first communication unit.

9. The communication system according to claim 8, further comprising:
the notifying unit having light emitting unit; and
the terminal detection unit having a luminance detection unit and that detects the notification from the notifying unit according to a state of illumination being detected by the light emission unit.

10. The portable terminal used in the communication system defined in claim 1.

11. The cradle used in the communication system defined in claim 1.

12. The communication system according to claim 2, wherein the cradle has a luminance detection unit, wherein the open state detection unit detects placement of the opened portable terminal according to a change in luminance resulting from the opened portable terminal being placed in the cradle.

13. The communication system according to claim 3, wherein the cradle has a luminance detection unit, wherein the open state detection unit detects placement of the opened portable terminal according to a change in luminance resulting from the opened portable terminal being placed in the cradle.

14. The portable terminal used in the communication system defined in claim 8.

15. The portable terminal used in the communication system defined in claim 10.

16. The cradle used in the communication system defined in claim 10.

17. The cradle used in the communication system defined in claim 8.
